(19) United States
(12) Patent Application Publication
(10) Pub. No.: US 2012/0198858 A1
(43) Pub. Date: Aug. 9, 2012

(54) RING ELEMENT AND TURBOMACHINE HAVING SUCH A RING ELEMENT

(75) Inventors: Johannes RABE, Dachau (DE); Franz-Dieter SCHMIDT, Bad Toelz (DE); Wilfried SCHUETTE, Oberhaching-Furth (DE)

(73) Assignee: MTU Aero Engines GmbH, Munich (DE)

(21) Appl. No.: 13/364,172

(22) Filed: Feb. 1, 2012

(30) Foreign Application Priority Data
Feb. 4, 2011 (DE) 10 2011 010 327.9

(51) Int. Cl. F01D 5/26; F02C 3/04; F01D 5/32

(52) U.S. Cl. 60/805; 416/140; 416/220 R; 416/500

(57) ABSTRACT

A ring element for a turbomachine, in particular for an aircraft gas turbine, is disclosed. The ring element has a ring element main body that has two adjacently arranged ring ends, the ring ends being connected to one another in a form-locking manner with respect to an axial plane. Also disclosed is a turbomachine having at least one such ring element.

This application claims the priority of German Patent Document No. DE 10 2011 010 327.9, filed Feb. 4, 2011, the disclosure of which is expressly incorporated by reference herein.

### BACKGROUND AND SUMMARY OF THE INVENTION

The invention relates to a ring element and to a turbomachine having such a ring element.

A vibration damping mechanism by means of ring elements may be provided in particular for damping and limiting the blade tilt of turbine blades in the compressor region of a gas turbine, such as for example an aircraft gas turbine. Ring elements of this type, such as for example damper rings or damper wires, are often accommodated in a groove of the component, the groove being formed, for example, in a rotor of a compressor. Ring elements have two adjacently arranged ring ends that are movable relative to one another and relative to the surrounding environment thereof in the ring groove.

Ring element arrangements of this type have the shortcoming that fretting occurs, in particular due to vibrations of the ring ends on both side surfaces of the ring groove that is provided for accommodating the ring elements and on adjacent components, such as for example the blade platform of a compressor blade. Moreover, the ring ends can move so as to extend into the gas flow path, thereby negatively impacting the flow conditions.

In view of the foregoing, it is the aim of the invention to create a ring element and a turbomachine having such a ring element, in which the wear of components in the region of the ring ends of the ring element is at least reduced.

The ring element according to the invention is provided preferably for accommodation in a ring groove, in particular of a turbomachine, such as for example an aircraft gas turbine, and has a ring element main body that has two adjacently arranged ring ends. According to the invention, the ring ends are connected to one another in a form-locking manner with respect to an axial plane. Wear of and damage to the component, such as in particular a compressor drum of an aircraft gas turbine, and adjacent components in the region of the ring ends, for example blade platforms of compressor blades, are at least greatly minimized because of the defined guidance of the ends. The operating safety is significantly improved as a result, and a longer component service life is attained. Because of the guided ring ends, the ring element can be arranged in the ring groove so as to freely rotate. The interconnection of the end sections prevents the ring ends from moving into the gas flow path. Furthermore, twisting of the ring ends, with the associated signs of wear and damage is prevented. Ring elements according to the invention may be provided as damper rings for vibration damping, in particular for damping and limiting the blade tilt of turbine blades in the compressor region of a gas turbine, such as for example an aircraft gas turbine. It is advantageous in this context that the damping behavior remains substantially unchanged also in the region of the ring ends since the damping mass in the connecting region of the ring ends changes only minimally. Additionally or alternatively, the ring elements may fulfill a holding function for blades that are inserted in axial grooves, and serve for axially securing the blades.

According to a particularly preferred embodiment of the invention, a first ring end has two guiding legs for approximately centrical accommodation of a guiding protrusion of a second ring end. As a result, the ring ends are guided according to the principle of a tongue-and-groove-connection in a form-locking manner with respect to the axial plane. Preferably, the side surfaces of an adjacent ring will end extend in common planes.

The guiding protrusion is provided preferably on the groove side with a bevel or rounding in the region of the end section. The bevel or rounding may be designed in such a way that the end section does not have any wear-promoting, sharp-edged contact with the groove bottom. In a preferred embodiment the guiding protrusion has an approximately rectangular cross section. The body edges may be rounded or beveled overall. This reduces or prevents wear of and damage to the contact partner.

The transition regions, such as for example the lateral transitions, between the ring element main body and the guiding protrusion are preferably provided with roundings or bevels. The radially outwardly situated surface of the guiding protrusion is provided in the region of the end section preferably with a rounding. With this solution, wear of and damage to the contact partner are further reduced.

It has proven particularly advantageous if the guiding legs extend substantially parallel to one another. The distance between the guiding legs in this arrangement corresponds substantially to the width of the guiding protrusion plus a slight clearance. In this manner an axially form-locking connection similar to a sliding fit is achieved that meets the high demands placed on the interconnection of the ring ends.

The end sections of the guiding legs are preferably provided with at least one bevel or a rounding, in particular on the inner radius, that is to say, radially inwardly and/or axially outwardly in the region of outer surfaces, such that signs of wear are at least reduced in this region as well.

In the installed state of the ring element, a gap is preferably formed between the ring element main body and each respective adjacently arranged ring end. Furthermore, it is advantageous if an overlap area of the ring ends is provided. Because of the gaps, the ring ends are slidable relative to one another in a tangential direction, such that the circumference of the ring element can be varied in a defined manner, the overlap area enabling a guided connection with minimized wear potential for the ring groove.

In a particularly preferred enhancement of the invention at least one ring end is held back radially. In this solution the ring ends are guided, in addition to the form-locking guidance with respect to the axial plane, also in the radial direction.

The guiding legs are preferably connected to one another by a radially outwardly situated connecting leg. As a result, the first ring end has an approximately U-shaped cross section for guiding the guiding protrusion of the second ring end. The minimized areas of contact permit a further reduction of the wear of adjacent components.

According to an advantageous embodiment of the invention, the guiding protrusion is designed tapered with respect to the ring width, preferably approximately step-like, with transition radii. The guiding protrusion preferably extends symmetrically to the centrical axial plane of the ring end.

A turbomachine according to the invention, in particular an aircraft gas turbine, includes at least one ring element according to the invention.

The ring element according to the invention may preferably be arranged between a blade platform and the rotor, in particular a compressor rotor. Preferably, at least one ring element is arranged axially in front of a row of blades and at least one ring element is arranged axially behind a row of blades of the compressor blade arrangement.

A preferred embodiment of the invention will be described below in conjunction with schematic drawings.

### BRIEF DESCRIPTION OF THE DRAWINGS

FIG. 1 shows a sectional view of an aircraft gas turbine in the region of the high-pressure compressor;

FIG. 2 shows an individual view of a sealing ring of FIG. 1;

FIG. 3 shows a detail view of a sealing ring of FIG. 1 in the region of the ring ends;

FIG. 4 shows a sectional view along the line F-F of FIG. 3;

FIG. 5 shows an enlarged individual view of a ring end of FIG. 3;

FIG. 6 shows a sectional view along the line E-E of FIG. 3; and

FIG. 7 shows a sectional view along the line C-C of FIG. 2.

### DETAILED DESCRIPTION OF THE DRAWINGS

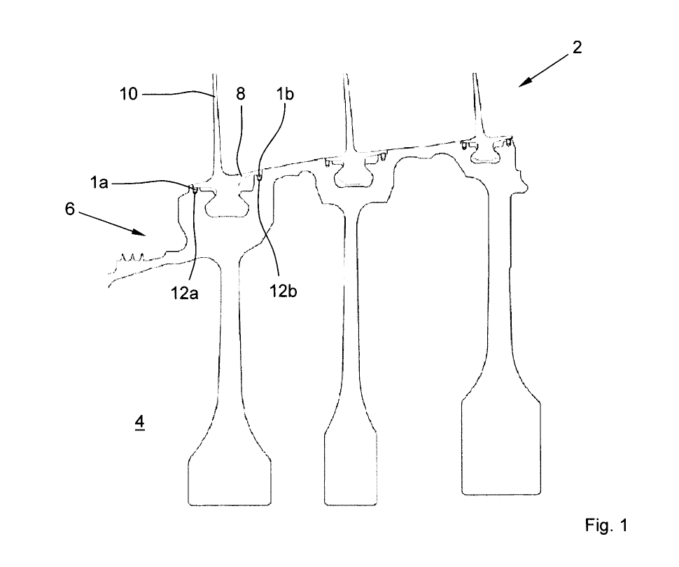

FIG. 1 shows, by way of example, the use of ring elements 1 according to the invention as damper and sealing rings in the region of a high-pressure compressor 2 of an aircraft gas turbine 4. The invention is not limited, however, to the use of the ring elements 1 in this region, but the ring elements 1 may also advantageously be used in other regions.

The ring elements 1 are arranged in the embodiment shown between a compressor rotor 6 and blade platforms 8 of compressor blades 10 for damping and limiting the blade tilt in such a way that each compressor stage has one ring element 1a associated therewith axially in front of a row of blades of the compressor blades 10 and one ring element 1b axially behind the row of blades of the compressor blade arrangement 10. The ring elements 1 each are arranged in an approximately U-shaped, radially outwardly open ring element groove 12a, 12b of the compressor rotor 6. This is explained by way of example in conjunction with the compressor stage shown in FIG. 1 as the first stage of three axially successive compressor stages of the high-pressure compressor 2.

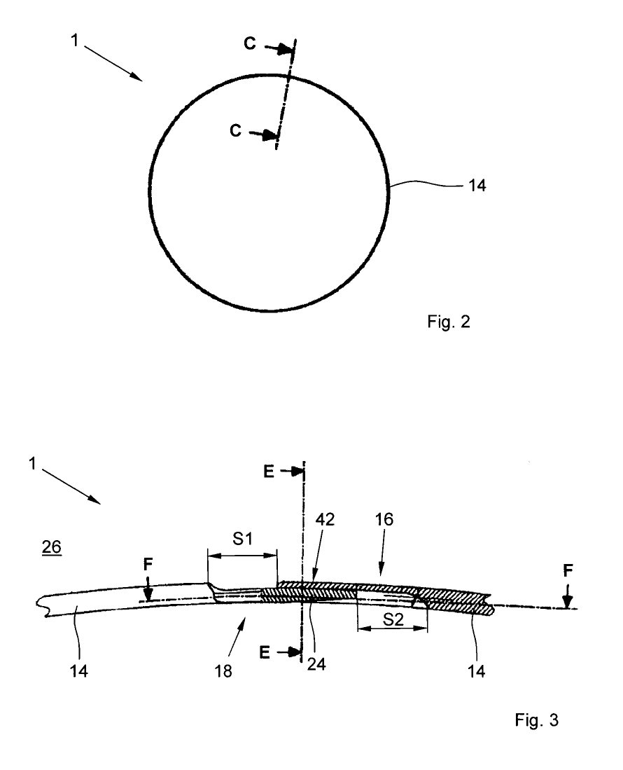

As can be seen in particular from FIGS. 2 and 3, which show an individual view and an enlarged detail view of a ring element 1 of FIG. 1, the ring elements 1 have a circular ring element main body 14 that has two adjacently arranged ring ends 16, 18.

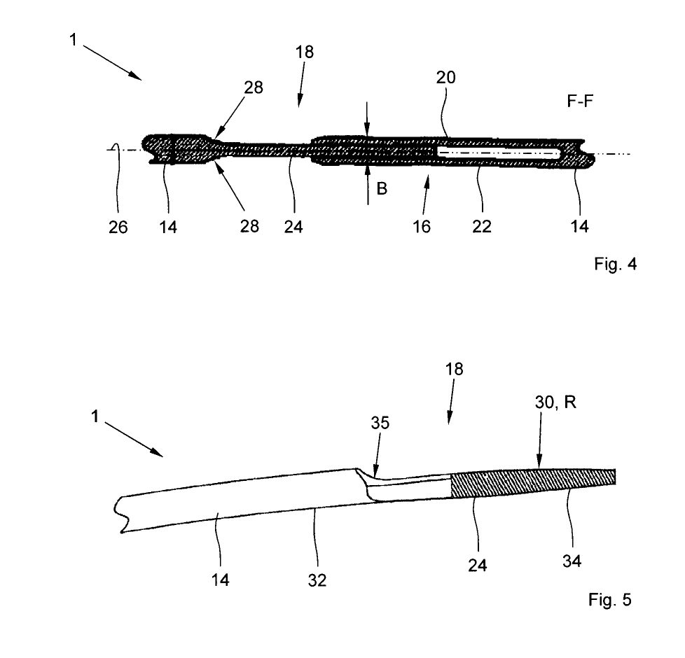

According to FIG. 4, which shows a sectional view of the ring element 1 along the line F-F of FIG. 3, the first ring end 16 of the ring element 1 has two guiding legs 20, 22 for centrical, sliding accommodation of a guiding protrusion 24 of the second ring end 18. The guiding legs 20, 22 extend parallel to one another. As a result, the ring ends 16, 18 are guided according to the principle of a tongue-and-groove connection in a form-locking manner with respect to an axial plane 26 which, in the embodiment shown, extends centrically through the ring element 1. The wear of and damage to the compressor rotor 6 and adjacent components in the region of the ring ends 16, 18 are at least greatly minimized due to the limited mobility of the ends. The operating safety is significantly improved as a result, and a longer component service life is attained. The lateral transition regions 28 between the ring element main body 14 and the guiding protrusion 24 are provided with concave roundings 28, such that the lateral wall wear is further minimized. The guiding protrusion 24 extends symmetrically to the centrical axial plane 26 of the ring end 18, the guiding protrusion 24 being designed tapered approximately step-like with transition radii 28 with respect to the ring width B.

As can be seen particularly from FIG. 5, which shows an enlarged individual view of the ring end 18 of FIG. 3 in the region of the guiding protrusion 24, the radially outwardly situated surface 30 of the guiding protrusion 24 is provided in the region of the end section with a relatively large radius R. The guiding protrusion 24 is provided in the region of the inner circumference thereof, that is to say, on a groove side 32, at the end section thereof with a bevel 34 and is therefore designed tapered toward the end. The bevel 34 is designed such that the end section does not have any wear-promoting, sharp-edged contact with the groove bottom of the ring groove. As a result, damage to the contact partner is prevented. In the region of the outer circumference side the ring element main body 14 is tapered toward the guiding protrusion 24 in a step-like manner via a concave transition section 35.

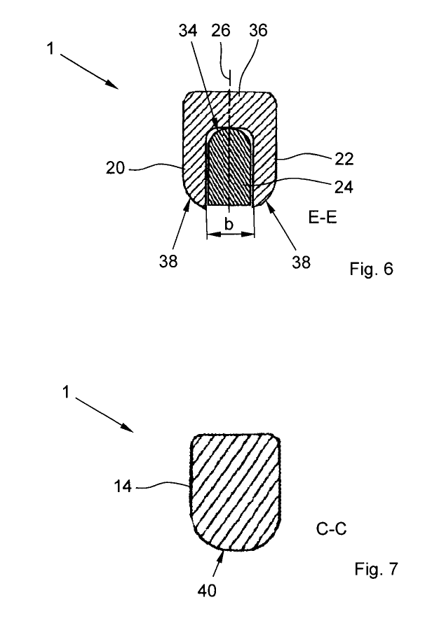

According to FIG. 6, which shows a sectional view of the ring element 1 along the line E-E of FIG. 3, the guiding protrusion 24 of the second ring end has an approximately rectangular cross section having a radially outwardly situated rounding 34 that connects the side surfaces of the guiding protrusion 24. The guiding legs 20, 22 of the first ring end extend parallel to one another. In this solution the ring ends are guided, in addition to the form-locking guidance with respect to the axial plane 26, also in the radial direction, in such a way that one ring end is held back radially. The guiding legs 20, 22 are connected for this purpose by a radially outwardly situated connecting leg 36. As a result, the first ring end has an approximately U-shaped cross-section for guiding the guiding protrusion 24 of the second ring end. The distance between the two guiding legs 20, 22 corresponds substantially to the width b of the guiding protrusion 24 plus a slight clearance, such that the two ring ends complement one another at the ends thereof to form a common guiding member (see FIG. 3). The end sections of the guiding legs 20, 22 are provided radially inwardly with a rounding 38, such that signs of wear are at least reduced in this region as well.

As can be seen from FIG. 7, which shows a sectional view of the ring element 1 along the line C-C of FIG. 2, the ring element main body 14 has an approximately rectangular cross-section which is provided radially inwardly with a rounding 40 that, as shown in FIG. 6, continues by way of the guiding legs 20, 22 in the form of roundings 38.

In the installed state of the ring element 1, a gap S1, S2 is formed, according to FIG. 3, between the ring element main body 14 and each of the adjacently arranged ring ends 16 and 18. Additionally it is advantageous that an overlap area 42 of the ring ends 16, 18 is formed. Because of the gaps S1, S2, the ring ends 16, 18 are arranged slidable relative to one another in a tangential direction, such that the circumference of the ring element 1 can vary in a defined manner, the overlap area 42 enabling a guided connection with minimized wear potential for the ring groove 12 and blade platforms 8 (see FIG. 1).

Disclosed is a ring element 1 for a turbomachine, in particular for an aircraft gas turbine 4, having a ring element main body 14 that has two adjacently arranged ring ends 16, 18, the ring ends 16, 18 being connected to one another in a form-locking manner with respect to an axial plane 26. Also disclosed is a turbomachine having at least one such ring element 1.

### LIST OF REFERENCE SYMBOLS

1 ring element

2 high-pressure compressor

4 aircraft gas turbine

6 compressor rotor

8 blade platform

10 compressor blade

12 ring element groove

14 ring element main body

16 ring end

18 ring end

20 guiding leg

22 guiding leg

24 guiding protrusion

26 axial plane

28 transition region

30 surface

32 groove side

34 rounding

35 transition section

36 connecting leg

38 rounding

40 rounding

42 overlap area

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A ring element for a turbomachine, comprising:
a ring element main body that has a first ring end and a second ring end, wherein in an installed state, the first ring end and the second ring end are adjacent to each other and wherein the first ring end and the second ring end are connected to one another in a form-locking manner with respect to an axial plane.

2. The ring element according to claim 1, wherein the first ring end has two guiding legs and wherein, in the installed state, a guiding protrusion of the second ring end is disposed within the two guiding legs.

3. The ring element according to claim 2, wherein the guiding protrusion has, at least in a region of an end section, a bevel and/or a rounding.

4. The ring element according to claim 2, wherein at least one transition region between the ring element main body and the guiding protrusion has a rounding and/or a bevel.

5. The ring element according to claim 2, wherein the two guiding legs extend substantially parallel to one another.

6. The ring element according to claim 2, wherein a respective end section of the two guiding legs has a bevel and/or a rounding.

7. The ring element according to claim 7, wherein the respective end sections are on an inner radius and/or axially outwardly.

8. The ring element according to claim 1, wherein, in the installed state, a first gap exists between the ring element main body and an end of the first ring end, a second gap exists between the ring element main body and an end of the second ring end, and the end of the first ring end and the end of the second ring end overlap.

9. The ring element according to claim 1, wherein at least one of the first and second ring ends is held back radially.

10. The ring element according to claim 2, wherein the two guiding legs are connected by a radially outwardly disposed connecting leg.

11. The ring element according to claim 2, wherein the guiding protrusion has a taper with respect to a width of the ring element main body.

12. The ring element according to claim 11, wherein the taper is a step-like taper with a transition radius and extends symmetrically to a centrical axial plane of the second ring end.

13. A turbomachine having a ring element according to claim 1.

14. The turbomachine according to claim 13, wherein the turbomachine is an aircraft gas turbine.

15. The turbomachine according to claim 13, wherein the ring element is disposed between a blade platform and a rotor.

16. The turbomachine according to claim 15, wherein the rotor is a compressor rotor of an aircraft gas turbine.

17. A turbomachine, comprising:
a blade platform;
a rotor; and
a ring element disposed between the blade platform and the rotor;
wherein the ring element includes a main body that has a first ring end and a second ring end, wherein the first ring end and the second ring end are adjacent to each other, and wherein the first ring end and the second ring end are connected to one another in a form-locking manner with respect to an axial plane.
